(19) United States
(12) Patent Application Publication
(10) Pub. No.: US 2015/0154567 A1
(43) Pub. Date: Jun. 4, 2015

(54) FACILITY MANAGEMENT SYSTEM USING PERSPECTIVE DEFINITION METADATA AND METHOD THEREFOR

(71) Applicant: KOREA INSTITUTE OF CONSTRUCTION TECHNOLOGY, Goyang-si (KR)

(72) Inventors: Tae Wook KANG, Seoul (KR); Hyun Sang CHOI, Goyang-si (KR)

(21) Appl. No.: 14/313,178

(22) Filed: Jun. 24, 2014

(30) Foreign Application Priority Data
Dec. 3, 2013 (KR) 10-2013-0149113

(51) Int. Cl. G06Q 10/00; G06Q 50/08

(52) U.S. Cl. CPC G06Q 10/20; G06Q 50/08

(57) ABSTRACT

A facility management system and a method thereof using perspective definition metadata, and more specifically, to a facility management system and a method thereof using perspective definition metadata, in which a perspective definition metadata structure for interconnecting Building Information Modeling (BIM) and external Facility Management (FM) data considering variability and expandability from the perspective of a user is used to improve expandability of the system by extracting information required for the role of the user from diverse heterogeneous data sources so that management and reusability functions of the system can be maximized even after the system is developed.

### BACKGROUND OF THE INVENTION

1. Field of the Invention

The present invention relates to a facility management system and a method thereof using perspective definition metadata, and more specifically, to a facility management system and a method thereof using perspective definition metadata, in which a perspective definition metadata structure for interconnecting Building Information Modeling (BIM) and external Facility Management (FM) data considering variability and expandability from the perspective of a user is used to improve expandability of the system by extracting information required for the role of the user from diverse heterogeneous data sources so that management and reusability functions of the system can be maximized even after the system is developed.

2. Background of the Related Art

Recently, studies on management of facilities based on Building Information Modeling (BIM) are under progress, and interoperability among heterogeneous data sources considering expandability and convenience from the perspective of a user is emerging as an issue.

In the field of construction, although a Building Smart Association or the like is trying to develop and standardize Industry Foundation Classes (IFC) and accommodate requirements of the industry for smooth interoperatility of information, a problem such as loss or modification of some information when data are exchanged among models in the working level is reported (Lim Jae-In, 2008.6).

Although it is tried to solve the problem of ambiguity or the like in the expression of construction information through the recently announced IFC4, it is a part which is still under improvement, and associations among the related measures are insufficient. If the perspective of a system user is fixed and invariable when a Facility Management (FM) system is implemented, there may be a problem in the management and reusability functions of the system since the system cannot be expanded.

As a conventional related technique, a technique using a Model View Control (MVC) pattern in a software architecture design pattern developed in the field of software engineering may be one of techniques related to expressing and processing information according to a perspective of a user using BIM.

The design pattern is a method contrived to solve the system design problem of a specific area, which is defined by Erich Gamma et al. who are called as Gang of Four (GoF) by patterning the design knowhow found in the process of solving the problems frequently appeared in the development of a system.

The MVC pattern is a structure designed to separate a data model, a controller for processing data and a view for expressing the data so that other components may not be affected although the view is changed. Therefore, since views of diverse perspectives can be defined by deriving a view from a base class, perspectives of information expression desired by a user can be easily expanded. In addition, since the model is independent of the controller having business logic, it is not affected although the logic is changed, and thus managability is improved.

A technique developed by Umit Isikdag focusing on a collaborative process among interested parties of a project in a BIM-based process is a technique utilizing a design pattern for BIM. Utilization of a design pattern is proposed as a method of synchronizing information needed for a view according to a perspective of viewing information generated in the collaborative process, and a method of applying the MVC pattern to a domain and a method of processing an event by an MVC-related component to synchronize information when a change is occurred in the model are described and developed (Umit Isikdag, Jason Underwood, 2010, Two design patterns for facilitating Building Information Model-based synchronous collaboration, Automation in Construction, 19, 544-553).

A design pattern technique for supporting a Service Oriented Architecture (SOA) to share BIM information based on the web is another related technique, and this technique has proposed an SOA which applies three design patterns to efficiently exchange and share the web-based BIM information (Umit Isikdag, 2012, Design patterns for BIM-based service-oriented architectures, Automation in Construction, 25, 59-71).

However, although the MVC design pattern supports expressions of information according to a perspective, since the perspective of information expression is fixed when a system is developed, the system cannot have variability and expandability after being developed.

An Extract Transform Load (ETL) technique or the like for constructing a Data Warehouse (DW) in the field of management engineering or the like is a technique related to interconnection of heterogeneous system data.

In the field of GIS, the DW is expanded to a Spatial Data Warehouse (SDW) by including spatial data, and a study on storing spatial information and non-spatial property information as subject-oriented, integrated and time-variant nonvolatile data has been conducted to support analysis and decision making (S. Chaudhuri, 1997).

The SDW can be created and updated to be subject-oriented through the ETL. It is disclosed that, in a technique related to the BIM, spatial data extracted and stacked from diverse heterogeneous system data through an EFL process should have a structure capable of supporting a data analysis request on the DW (Konstantin Krivoruchko, 2003).

In addition, a technique developed by H. Ufuk Gokce and K. Umut Gokce is another related technique, and there is an example of implementing a system by extracting, transforming and stacking data using an ETL in an energy management system (H. Ufuk Gokce, 2011).

The technique developed as described above points out that utilization of a single integrated information model is difficult in an environment in which interested parties of a project use a database in a different way. In order to avoid such a problem, sensor data including multi-dimensional data and architecture of extracting building information from data sources are proposed.

In a technique related to BIM-based facility management, Ko (Ko, Y. H. 2008, A Study on the Development of a BIM-Based Building Process of CAFM Basic Data, Seoul National University of Technology) pointed out that the cost required for developing BIM-based Computer Aided Facility Management (CAFM) is too high if BIM data are used when the CAFM is constructed, and proposed a technique capable of using the BIM data that can be utilized in the stage of FM based on IFC and Construction Operations Building Information Exchange (COBie). However, the method has only been proposed, and its utilization has never been verified through a demonstration.

Lim (Lim, H. S. 2011.7, BIM-based Mobile System for Facility Operation Improvement, Yonsei University) has focused on improvement of communication through smooth exchange of information among management subjects through a mobile BIM-based management system and support of a smooth work by constructing plans and maintenance works as a database.

An (An, H. K, Lee, S. K, Yu, J. H, Jang, H. S, Son, B. S. 2012.11, Information Requirements Analysis for BIM-based Facility Management Systems, Architectural Institute of Korea, 28(11):133-142) has reviewed requirement information data, divided the data into prerequisite information, recommended information and selective information, and proposed data which can be referenced when a facility management system is constructed, based on the COBie through consultation in order to define requirements for a BIM-based facility management system.

Conclusively, observing the techniques related to the present invention, techniques applying a design pattern for collaboration or web-based information sharing are studied, and a research which has developed a SDW in the field of GIS has been conducted as a study related to extraction and transformation of external heterogeneous data. Techniques related to the BIM-based FM are mostly a technique related to construction of a database or utilization of a COBie format, and techniques related to the metadata structure for interconnecting the BIM and external FM data considering variability and expandability from the perspective of a user are insufficient.

### SUMMARY OF THE INVENTION

Therefore, the present invention has been made in view of the above problems, and it is an object of the present invention to provide a facility management system and a method thereof using perspective definition metadata, in which a perspective definition metadata structure for interconnecting Building Information Modeling (BIM) and external Facility Management (FM) data considering variability and expandability from the perspective of a user is used to improve expandability of the system by extracting information required for the role of the user from diverse heterogeneous data sources so that management and reusability functions of the system can be maximized even after the system is developed.

To accomplish the above object, according to one aspect of the present invention, there is provided a facility management system using perspective definition metadata, the system including: a central server 100 for receiving a request for maintenance from a user terminal 200, confirming work/maintenance history information from the facility management database 110, confirming information on a location, a structure and history of work/maintenance from the facility management database 110, transmitting a request for a quotation of the work of a company to the facility management company server 300, receiving a request for data related to the work on a site from the facility management company server 300, transmitting the data related to the field work to the facility management company server 300, receiving information on the quotation of the work of the company from the facility management company server 300, requesting the management information system 400 to approve progress of the work, receiving information on approval of progressing the work from the management information system 400, transmitting a contract with the company and a request for the work to the facility management company server 300, receiving information on results and products before and after the maintenance work from the facility management company server 300, transmitting a request for on-site confirmation on the result of the maintenance work to the user terminal 200, updating history of drawings and documents in the facility management database 110, receiving a request for payment of work expenses from the facility management company server 300, requesting the management information system 400 to approve the work expenses, receiving approval of the work expenses and information on registration of history from the management information system 400, receiving the result of the maintenance work from the user terminal 200, and transmitting information on the payment of the work expenses to facility management company server 300; a user terminal 200 for transmitting a request for maintenance to the central server 100, receiving a request for on-site confirmation on the result of the maintenance work from the central server 100, and transmitting the result of the maintenance work to the central server 100; a facility management company server 300 for receiving a request for a quotation of the work of the company from the central server 100, transmitting a request for data related to the field work to the central server 100, receiving the data related to the field work from the central server 100, transmitting information on the quotation of the work of the company to the central server 100, receiving a contract with the company and a request for the work from the central server 100, transmitting information on results and products before and after the maintenance work to the central server 100, transmitting a request for payment of work expenses to the central server 100, and receiving information on the payment of the work expenses from the central server 100; and a management information system 400 for receiving a request for approving progress of the work from the central server 100, transmitting information on approval of progressing the work to the central server 100, receiving a request for approving the work expenses from the central server 100, and transmitting approval of the work expenses and information on registration of history to the central server 100.

At this point, the central server 100 includes: a collection means for collecting heterogeneous data related to facility management from a separate system in a form of an XML file; a classification means for classifying the heterogeneous data collected by the collection means according to a classification target criterion configured of a user's perspective, a manager's perspective and a worker's perspective; and an expression means for expressing the heterogeneous data classified by the classification means on a screen of the user terminal 200, a separate manager terminal or a separate worker terminal in a classified style.

According to another aspect of the present invention, there is provided a facility management method using perspective definition metadata, the method including the steps of: (A) receiving a request for maintenance from a user terminal 200, by a central server 100; (B) confirming information on a location, a structure and history of work/maintenance from a facility management database 110, by the central server 100; (C) transmitting a request for a quotation of the work of a company to a facility management company server 300, by the central server 100; (D) receiving a request for data related to the work on a site from the facility management company server 300, and transmitting the the data related to the field work to the facility management company server 300, by the central server 100; (E) receiving the quotation of the work of the company from the facility management company server 300, by the central server 100; (F) requesting a management information system 400 to approve progress of the work, and receiving approval of progressing the work from the management information system 400, by the central server 100; (G) transmitting a contract with the company and a request for the work to the facility management company server 300, and receiving information on results and products before and after the maintenance work from the facility management company server 300, by the central server 100; (H) transmitting a request for on-site confirmation on the result of the maintenance work to the user terminal 200, by the central server 100; (I) receiving a request for payment of work expenses from the facility management company server 300, by the central server 100; (J) requesting the management information system 400 to approve the work expenses, and receiving approval of the work expenses and information on registration of history from the management information system 400, by the central server 100; (K) receiving the result of the maintenance work from the user terminal 200, and by the central server 100; and (L) transmitting information on the payment of the work expenses to facility management company server 300, by the central server 100.

### BRIEF DESCRIPTION OF THE DRAWINGS

FIG. 1 is a reference view related to an FM work for conventional facility management.

FIG. 2 is a view showing the entire configuration of a facility management system using perspective definition metadata according to a preferred embodiment of the present invention.

FIG. 3 is an entire flowchart illustrating a facility management method using perspective definition metadata according to a preferred embodiment of the present invention.

### DESCRIPTION OF SYMBOLS

100: Central server 110: Facility management database 200: User terminal 300: Facility management company server 400: Management information system

### DETAILED DESCRIPTION OF THE PREFERRED EMBODIMENT

Before describing the preferred embodiments of the present invention in detail, terms and words used in this specification and claims should be interpreted as meanings and concepts to meet the technical ideas of the invention based on the principles that can define adequately the concept of the terms so that the inventor can explain his or her invention in the best way.

In addition, if already known functions or specific description of constitution related to the present invention may make the spirit of the present invention unclear, detailed description thereof will be omitted.

The inventors of the present invention have completed the present invention by developing a BIM-based Perspective Definition Metadata (BPD) structure which can interconnect BIM and external Facility Management (FM) data considering variability and expandability from the perspective of a user.

Since the perspective definition metadata supports variability of a system for adding or changing perspectives of a user even after the system is developed, it may be helpful in expanding and reusing the system. Since the perspective definition metadata extracts only the data needed from the perspective of a user from heterogeneous data sources and transforms the extracted data to be shown in a style desired by the user, it is configured of a data model defining data which will be extracted, transformation logic defining how to transform the extracted data, and a view defining how to show the transformed data.

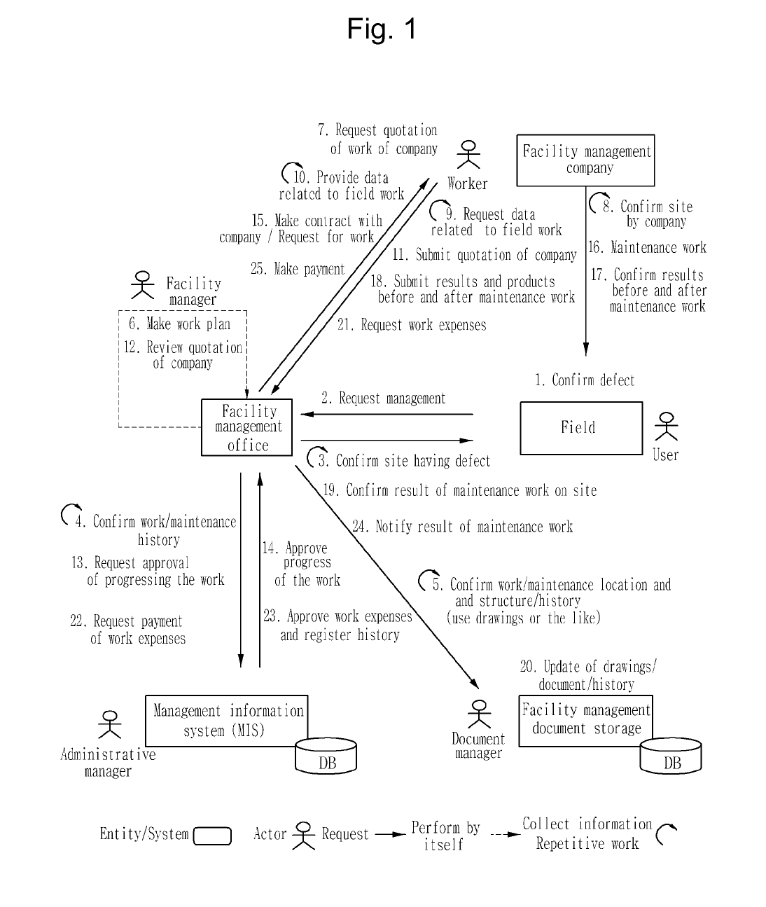

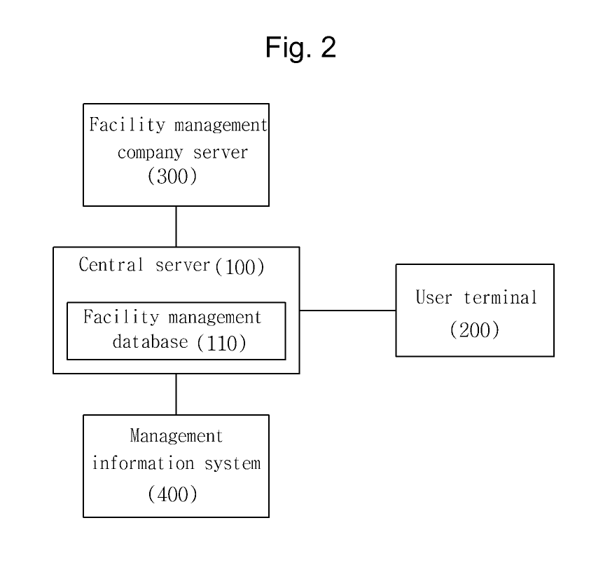

Hereinafter, a facility management system using perspective definition metadata according to a preferred embodiment of the present invention will be described in detail with reference to FIGS. 1 and 2.

FIG. 1 is a reference view related to an FM work for conventional facility management, and FIG. 2 is a view showing the entire configuration of a facility management system using perspective definition metadata according to a preferred embodiment of the present invention.

An FM work scenario applied to conventional facility management or the like by a public organization or the like which manages facilities is as described below, and this is shown in FIG. 1. A facility management work has an extremely complicated work flow, and various interested parties of a project take part in the work. If a defect occurs in a facility, a management company, a technique thereof or the like will be changed according to the type of the facility, and it takes a long time in many cases to collect related data and identify a cause in the process of a maintenance work.

1. A user confirms a defect of a facility.

2. The user requests maintenance of the facility.

3. A facility manager visits the site and confirms the defect.

4. The facility manager confirms work/maintenance history.

Specifically, the facility manager confirms the work/maintenance history related to the defect and confirms information on a company or the like which has performed the work before.

5. The facility manager confirms a location, a structure and history of the work/maintenance. Specifically, the facility manager confirms information related to the facility to grasp causes and countermeasures of the defect using drawings or the like.

6. The facility manager makes a work plan.

7. The facility manager requests a quotation of the work from the company.

8. A worker confirms the site of the facility. Specifically, the worker grasps causes and makes a maintenance plan after confirming the site.

9. The worker requests data related to the field work.

10. The facility manager provides data related to the field work. Specifically, the facility manager collects and provides facility-related data requested by the company.

11. The worker submits the quotation of the company.

12. The facility manager reviews the quotation of the company.

13. The facility manager requests approval of performing the work.

14. The administrative manager approves progress of the work.

15. The facility manager makes a contract with the company and requests progress of the work.

16. The worker performs a maintenance work.

17. The worker confirms results before and after the maintenance work.

18. The worker submits the results and products before and after the maintenance work.

19. The facility manager performs on-site confirmation on the result of the maintenance work.

20. The facility manager updates history of drawings and documents.

21. The worker requests work expenses.

22. The facility manager requests approval of the work expenses.

23. The administrative manager approves the work expenses and registers history of the work.

24. The facility manager notifies the result of the maintenance work.

25. The facility manager makes a payment for the work.

Seeing a result of analyzing the work scenario described above, it is understood that since data and information on the site such as drawings, history information, related documents and the like are scattered, a lot of repetitive manual works are required in the process of personally visiting and confirming a facility management document storage or a site by a person, and the process of confirming the drawings or history information related to the facility is complicated.

If the period of warranty for the facility is expired when the history information is confirmed and a contract should be made with a new facility management company, the process of confirming and providing the data requested by the company in relation to the maintenance work from the facility management document storage, the management information system and the site is continuously repeated.

At this point, the facility information or history information is generally managed as a Word document or an Excel file. The drawings are managed as PDF files or partially non-electronized blue print drawings, and some pieces of information on the history of the work and maintenance are separately managed in the management information system (MIS).

In this circumstance, if a defect occurs in a facility, it takes a long time for the facility manager to search for the history information, documents, information on the management company, location of the site, MIS history information and the like connected around the facility, and it is also the same for the facility management company. This is one of the main factors which lowers efficiency of a work in managing the facility.

If the processes of confirming and collecting the scattered data can be integrated around a facility object unlike the conventional processes described above, efficiency of a work for requesting, searching, confirming and integrating the facility management data can be improved. If a facility is defined as a BIM entity considering convenience of confirming, searching and managing the data and related information is searched for in connection with the BIM entity, the problems described above can be improved.

Accordingly, if the facility management system using perspective definition metadata as shown in FIG. 2 is completed, a central server at the center manages a facility management database, and thus diversely scattered data can be integrated and centrally processed in response to a request of other constitutional components.

According to a preferred embodiment of the present invention, an effect of improving at least six processes of the conventional FM work scenario (5. The facility manager confirms a location, a structure and history of the work/maintenance. 8. A worker confirms the site of the facility. 9. The worker requests data related to the field work. 10. The facility manager provides data related to the field work. 18. The worker submits the results and products before and after the maintenance work. 20. The facility manager updates history of drawings and documents.) can be accomplished.

In FIG. 2, the facility management system using perspective definition metadata according to a preferred embodiment of the present invention may be configured to include a central server 100, a user terminal 200, a facility management company server 300 and a management information system 400, and the central server 100 includes a facility management database 110.

The central server 100 receives a request for maintenance from the user terminal 200, confirms a site having a defect, confirms work/maintenance history from the facility management database 110, confirms a location, a structure and history of the work/maintenance from the facility management database 110, makes a work plan, transmits a request for a quotation of the work of a company to the facility management company server 300, receives a request for data related to the field work from the facility management company server 300, transmits the data related to the field work to the facility management company server 300, receives the quotation of the work of the company from the facility management company server 300, reviews the quotation of the company, requests the management information system 400 to approve progress of the work, receives approval of progressing the work from the management information system 400, transmits a contract with the company and a request for the work to the facility management company server 300, receives results and products before and after the maintenance work from the facility management company server 300, transmits a request for on-site confirmation on the result of the maintenance work to the user terminal 200, updates history of drawings and documents in the facility management database 110, receives a request for payment of work expenses from the facility management company server 300, requests the management information system 400 to approve the work expenses, receives approval of the work expenses and information on registration of history from the management information system 400, receives the result of the maintenance work from the user terminal 200, and transmits information on the payment of the work expenses to facility management company server 300.

In addition, the user terminal 200 transmits a request for maintenance to the central server 100, receives a request for on-site confirmation on the result of the maintenance work from the central server 100, and transmits the result of the maintenance work to the central server 100.

In addition, the facility management company server 300 receives a request for a quotation of the work of the company from the central server 100, transmits a request for data related to the field work to the central server 100, receives the data related to the field work from the central server 100, transmits a quotation of the work of the company to the central server 100, receives a contract with the company and a request for the work from the central server 100, transmits results and products before and after the maintenance work to the central server 100, transmits a request for payment of work expenses to the central server 100, and receives information on the payment of the work expenses from the central server 100.

Then, the management information system 400 receives a request for approving progress of the work from the central server 100, transmits approval of progressing the work to the central server 100, receives a request for approving work expenses from the central server 100, and transmits approval of the work expenses and information on registration of history to the central server 100.

Additionally, an operator or a worker of the facility management company server 300 confirms offline a site where a defect is occurred, actually performs a maintenance work, and confirms offline results before and after the maintenance work.

Meanwhile, the central server 100 includes a collection means, a classification means and an expression means in order to use a metadata structure based on perspectives of information in a preferred embodiment of the present invention.

The collection means collects heterogeneous data related to an FM work, and the collection target heterogeneous data may be collected from a separate system in the form of an XML file, and the collected heterogeneous data can be stored in the facility management database 110.

The classification means classifies the heterogeneous data collected by the collection means according to a classification target criterion, and the classified heterogeneous data may also be stored in the facility management database 110, and the classification target criterion may include a user's perspective, a manager's perspective and a worker's perspective.

For example, when a facility manager logs in the central server 100, the manager may desire to confirm the state of the facility, or an operator operating the facility management company server 300 or a worker who actually carries out a maintenance work may desire to confirm information on the building structure or information on the maintenance history. Therefore, data required for each perspective should be collected in advance, and information classified according to the perspectives should be shown by the user, by the manager and by the worker.

In a preferred embodiment of the present invention, the user's perspective information among the information classified by the classification means may be information on a corresponding manager, information on the facility number, information on the area of the facility or the like, and the manager's perspective information may be information on the number of stories of the facility, information on the classification of the facility, information on the name of the facility, information on the date of facility, information on the area of the facility, information on the boundary of the facility, information on the size of the facility, information on the height of the facility or the like, and the worker's perspective information may be information on the current state of maintenance, information on the ratio of maintenance, information on the date of maintenance or the like.

Particularly, when the classification means classifies the heterogeneous data, the classification target data are expressed in a hierarchy of properties of data, such as a category, a name, a value, a type or the like, and extracted properties of the data are formalized as a category, a property name, a property value, a property type and the like using metadata and scripts. That is, they are expressed and processed as Property={Category, Name, Value, Type}.

The expression means expresses the classified heterogeneous data in an optimum style according to an entity which accesses the central server 100, such as a user, a manager or a worker, and they are displayed on the screen of the user terminal 200, a separate manager terminal or a separate worker terminal in the form of an XML file.

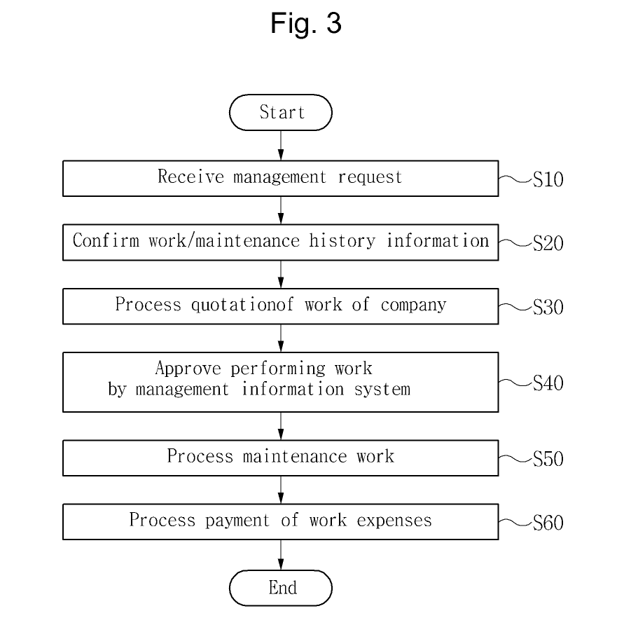

Hereinafter, a facility management method using perspective definition metadata according to a preferred embodiment of the present invention will be described in detail with reference to FIG. 3.

FIG. 3 is an entire flowchart illustrating a facility management method using perspective definition metadata according to a preferred embodiment of the present invention.

First, as shown in FIG. 3, the central server 100 receives a request for maintenance from the user terminal 200 and confirms information on a site having a defect (S10).

Next, the central server 100 confirms work/maintenance history information from the facility management database 110 and confirms information on the location, structure and history of the work/maintenance from the facility management database 110 (S20).

Next, the central server 100 creates work plan information, transmits a request for a quotation of the work of the company to the facility management company server 300, receives a request for data related to the field work from the facility management company server 300, transmits the data related to the field work to the facility management company server 300, and receives the quotation of the work of the company from the facility management company server 300 (S30).

Next, the central server 100 reviews the quotation of the company, requests the management information system 400 to approve progress of the work, and receives approval of progressing the work from the management information system 400 (S40).

Next, the central server 100 transmits a contract with the company and a request for the work to the facility management company server 300, receives results and products before and after the maintenance work from the facility management company server 300, transmits a request for on-site confirmation on the result of the maintenance work to the user terminal 200, and updates history of drawings and documents in the facility management database 110 (S50).

Finally, the central server 100 receives a request for payment of work expenses from the facility management company server 300, requests the management information system 400 to approve the work expenses, receives approval of the work expenses and information on registration of history from the management information system 400, receives a result of the maintenance work from the user terminal 200, and transmits information on the payment of the work expenses to facility management company server 300 (S60).

According to the present invention, there is an effect of providing a facility management system and a method thereof using perspective definition metadata, in which a perspective definition metadata structure for interconnecting Building Information Modeling (BIM) and external Facility Management (FM) data considering variability and expandability from the perspective of a user is used to improve expandability of the system by extracting information required for the role of the user from diverse heterogeneous data sources so that management and reusability functions of the system can be maximized even after the system is developed.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A facility management system using perspective definition metadata, the system comprising:
a central server for receiving a request for maintenance from a user terminal, confirming work/maintenance history information from the facility management database, confirming information on a location, a structure and history of work/maintenance from the facility management database, transmitting a request for a quotation of the work of a company to the facility management company server, receiving a request for data related to the work on a site from the facility management company server, transmitting the data related to the field work to the facility management company server, receiving information on the quotation of the work of the company from the facility management company server, requesting the management information system to approve progress of the work, receiving information on approval of progressing the work from the management information system, transmitting a contract with the company and a request for the work to the facility management company server, receiving information on results and products before and after the maintenance work from the facility management company server, transmitting a request for on-site confirmation on the result of the maintenance work to the user terminal, updating history of drawings and documents in the facility management database, receiving a request for payment of work expenses from the facility management company server, requesting the management information system to approve the work expenses, receiving approval of the work expenses and information on registration of history from the management information system, receiving the result of the maintenance work from the user terminal, and transmitting information on the payment of the work expenses to facility management company server;
a user terminal for transmitting a request for maintenance to the central server, receiving a request for on-site confirmation on the result of the maintenance work from the central server, and transmitting the result of the maintenance work to the central server;
a facility management company server for receiving a request for a quotation of the work of the company from the central server, transmitting a request for data related to the field work to the central server, receiving the data related to the field work from the central server, transmitting information on the quotation of the work of the company to the central server, receiving a contract with the company and a request for the work from the central server, transmitting information on results and products before and after the maintenance work to the central server, transmitting a request for payment of work expenses to the central server, and receiving information on the payment of the work expenses from the central server; and
a management information system for receiving a request for approving progress of the work from the central server, transmitting information on approval of progressing the work to the central server, receiving a request for approving the work expenses from the central server, and transmitting approval of the work expenses and information on registration of history to the central server.

2. The system according to claim 1, wherein the central server includes:
a collection means for collecting heterogeneous data related to facility management from a separate system in a form of an XML file;
a classification means for classifying the heterogeneous data collected by the collection means according to a classification target criterion configured of a user's perspective, a manager's perspective and a worker's perspective; and
an expression means for expressing the heterogeneous data classified by the classification means on a screen of the user terminal, a separate manager terminal or a separate worker terminal in a classified style.

3. A facility management method using perspective definition metadata, the method comprising the steps of:
(A) receiving a request for maintenance from a user terminal, by a central server;
(B) confirming information on a location, a structure and history of work/maintenance from a facility management database, by the central server;
(C) transmitting a request for a quotation of the work of a company to a facility management company server, by the central server;
(D) receiving a request for data related to the work on a site from the facility management company server, and transmitting the the data related to the field work to the facility management company server, by the central server;
(E) receiving the quotation of the work of the company from the facility management company server, by the central server;
(F) requesting a management information system to approve progress of the work, and receiving approval of progressing the work from the management information system, by the central server;
(G) transmitting a contract with the company and a request for the work to the facility management company server, and receiving information on results and products before and after the maintenance work from the facility management company server, by the central server;
(H) transmitting a request for on-site confirmation on the result of the maintenance work to the user terminal, by the central server;
(I) receiving a request for payment of work expenses from the facility management company server, by the central server;
(J) requesting the management information system to approve the work expenses, and receiving approval of the work expenses and information on registration of history from the management information system, by the central server;
(K) receiving the result of the maintenance work from the user terminal, and by the central server; and
(L) transmitting information on the payment of the work expenses to facility management company server, by the central server.
